(19) United States
(12) Patent Application Publication
(10) Pub. No.: US 2019/0098878 A1
(43) Pub. Date: Apr. 4, 2019

(54) MODULARLY ASSEMBLED WAVE MAKER

(71) Applicant: Shih-hui LIAO, Guangdong (CN)

(72) Inventor: Shih-hui LIAO, Guangdong (CN)

(21) Appl. No.: 16/128,066

(22) Filed: Sep. 11, 2018

Related U.S. Application Data
(63) Continuation of application No. PCT/CN2017/106777, filed on Oct. 19, 2017.

(30) Foreign Application Priority Data
Sep. 30, 2017 (CN) 201721291082.5

(51) Int. Cl. A01K 63/04

(52) U.S. Cl. CPC A01K 63/047

(57) ABSTRACT

A modularly assembled wave maker including: a housing internally provided with a power source with an output end extending out of the housing; and at least an impeller assembly with one end connected to the housing, including: an expanded structure for continuing the impeller assembly and an impeller body connected to an output end of the power source in a transmission way. The present invention adopting the above structure can be applied to continuously connect the impeller assembly as needed by arranging the expanded structure in the impeller assembly, so as to achieve the expansion of the present invention, which enables the present invention to be suitable for aquariums of different depths. Moreover, only a faulted part needs to be replaced when the present invention fails, so that the replacement cost is low. Therefore, the present invention has a simple structure, and is economically affordable.

### CROSS-REFERENCE TO RELATED APPLICATION

This application is a continuation of and claims priority to International Application No. PCT/CN2017/106777, filed Oct. 19, 2017, entitled MODULARLY ASSEMBLED WAVE MAKER, which is related to and claims priority to Chinese Application No. 201721291082.5, filed Sep. 30, 2017, entitled MODULARLY ASSEMBLED WAVE MAKER, the entirety of all of which is incorporated herein by reference.

### FIELD

The present invention relates to the field of aquarium products, and more particularly, to a modularly assembled wave maker.

### BACKGROUND

A wave maker is a device for generating water flow in an aquarium, and generally, an aquarium will be equipped with a wave maker. The existing wave maker has been assembled before leaving the factory and does not need to be assembled after leaving the factory, but at the same time, the later expansion of the wave maker is limited. For this reason, different wave makers may be required according to a depth of the aquarium. Thereby a variety of molds need to be opened by manufacturers, increasing production costs and ultimately leading to higher product price and lower competitiveness. In addition, if the existing wave maker is broken, the wave maker needs to be replaced as a whole, resulting in a high replacement cost. To this end, the present invention provides a modularly assembled wave maker for solving the problems above.

### SUMMARY

In order to solve the problem above, the present invention provides a modularly assembled wave maker.

The technical solution adopted by the present invention to solve the technical problem thereof is as follows.

A modularly assembled wave maker comprising:

a housing internally provided with a power source with an output end extending out of the housing; and

at least an impeller assembly with one end connected to the housing, the impeller assembly comprising an expanded structure for continuing the impeller assembly and an impeller body connected to an output end of the power source in a transmission way.

The impeller assembly further comprises an outer frame provided with an water inlet and water outlet, and a connector detachably connected to one end of the outer frame, wherein the impeller body has one end connected to the output end of the power source and the other end rotatably mounted on the connector via a rotating shaft extending out of the connector.

The expanded structure comprises a positioning device for docking of adjacent impeller assemblies and a fixing device for fixing a docking state of the adjacent impeller assemblies.

The positioning device comprises an annular bulge arranged at the connector and a docking portion arranged at an end portion of the outer frame away from the connector for cooperation with the annular bulge, and the outer frames of the adjacent impeller assemblies are positioned by inserting the annular bulge into the docking portion.

The fixing device comprises a connecting rod and a connecting hole arranged at a side of the connector, the adjacent impeller assemblies are fixed by inserting the connecting rod into the connecting hole, and the connecting rod is in interference fit with the connecting hole.

The connecting rod is fixedly connected to the connector at a middle portion of the connecting rod, and the connecting hole is arranged at one end of the connecting rod.

The present invention further comprises a first magnet and a second magnet, wherein the first magnet is mounted on the connecting rod, the first magnet and the second magnet are configured for fixing cooperatively the impeller assembly to a side wall of the aquarium.

A plurality of first baffles vertical to the rotating shaft are arranged at the water inlet, and a plurality of second baffles are arranged in the water outlet which are distributed in a four-square shape.

The housing is detachably connected at a side of the housing with a connecting block which is provided with a mounting hole in interference fit with the connecting rod.

The connecting block is provided with a clamping groove, and the housing is provided at a side of the housing with a clamping buckle cooperative with the clamping groove.

The present invention has the beneficial effects that: The present invention adopting the above structure can be applied to continuously connect the impeller assembly as needed by arranging the expanded structure in the impeller assembly, so as to achieve the expansion of the present invention, which enables the present invention to be suitable for aquariums of different depths. Moreover, only a faulted part needs to be replaced when the present invention fails, so that the replacement cost is low. Therefore, the present invention has a simple structure, and is economically affordable.

### BRIEF DESCRIPTION OF THE DRAWINGS

The present invention is further described hereinafter with reference to the accompanying drawings and the embodiments:

FIG. 1 is a schematic diagram of the present invention;

FIG. 2 is an exploded schematic diagram of the present invention; and

FIG. 3 is a cross-section view of the present invention.

### DETAILED DESCRIPTION

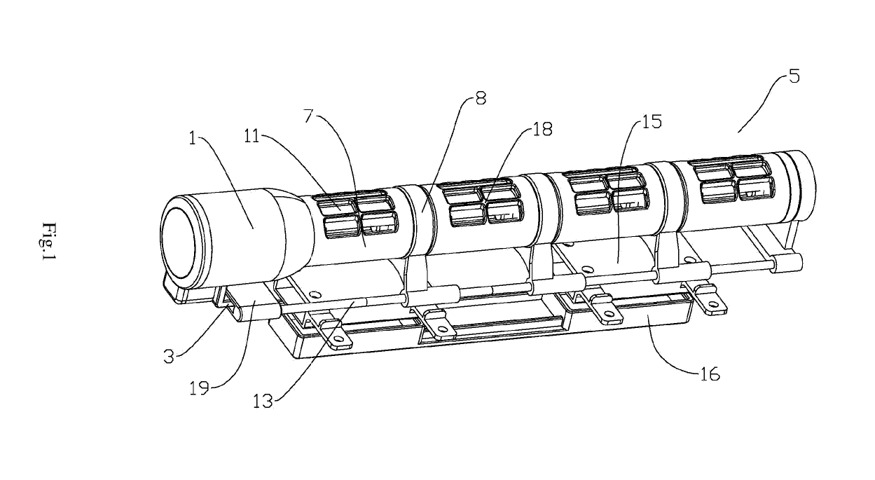

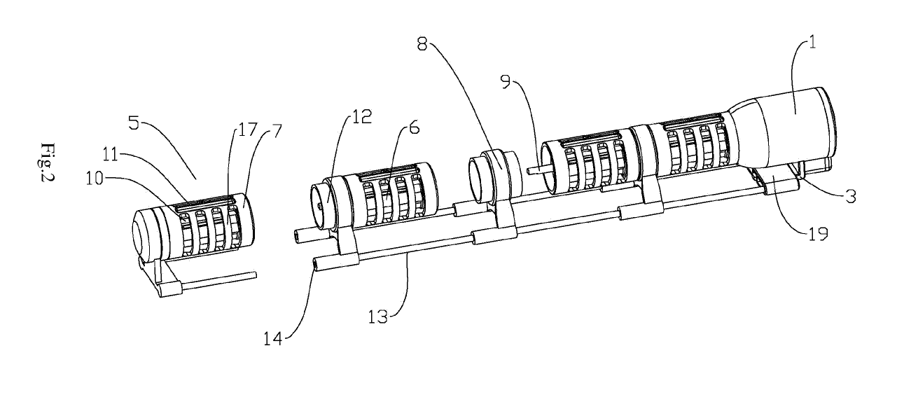

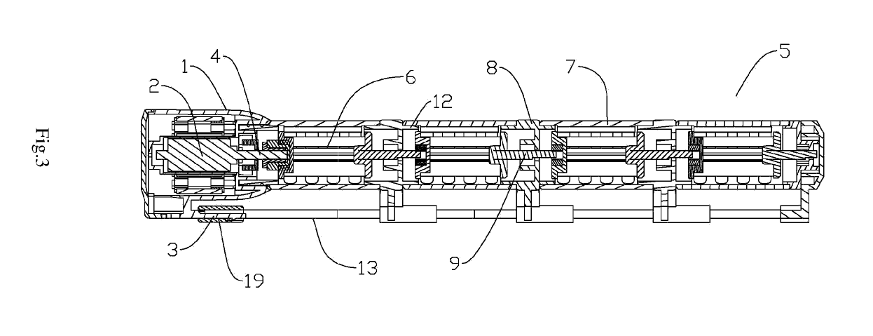

Referring to FIGS. 1 to 3, the present invention provides a modularly assembled wave maker comprising: a housing 1 internally provided with a power source 2 with an output end 4 extending out of the housing 1; and at least an impeller assembly 5 with one end connected to the housing 1, the impeller assembly 5 is further provided with an expanded structure for continuously connecting the impeller assembly 5, the impeller assembly 5 comprises an impeller body 6 connected to the output end 4 of the power source 2 in a transmission way. The present invention adopting the above structure can be applied to continuously connect the impeller assembly 5 as needed by arranging the expanded structure in the impeller assembly 5, so as to achieve the expansion of the present invention, which enables the present invention to be suitable for aquariums of different depths. Moreover, only a faulted part needs to be replaced when the present invention fails, so that the replacement cost is low. Therefore, the present invention has a simple structure, and is economically affordable.

As shown in the figures, the impeller assembly 5 further comprises an outer frame 7 of a cylindrical shape, and a connector 8 detachably connected to, and in this embodiment inserted into one end of the outer frame 7 to facilitate the transportation and replacement of parts at a later stage. One end of the impeller body 6 is connected to the output end 4 of the power source 2, the other end of the impeller body 6 is rotatably mounted on the connector 8 via a rotating shaft 9 which extends out of the connector 8 so as to connect the impeller body 6 of an expanded impeller assembly 5 in a transmission way. The outer frame 7 is provided with a water inlet 10 and a water outlet 11 at a side thereof. By rotation of the impeller body 6, water flow is driven to enter the outer frame 7 from the water inlet 10 and discharge from the water outlet 11 to form a stable water flow. Certainly, the outer frame 7 can also be fixedly connected to or integrally formed with the connecting base 8.

As shown in the figures, the expanded structure comprises a positioning device for docking adjacent impeller assemblies 5 together and a fixing device for fixing a docking state of the adjacent impeller assemblies 5. Quick docking of adjacent impeller assemblies 5 can be realized by the expanded structure. The following specific embodiments can be used in the positioning device comprising an annular bulge 12 arranged in the connector 8 and a docking portion fitted with the annular bulge 12 at an end portion of the outer frame 7 away from the connector 8. The outer frames 7 of the adjacent impeller assemblies 5 are positioned by inserting the annular bulge 12 into the docking portion, and the positioning device of the structure can realize quick positioning. The docking portion in the embodiment is a channel within the outer frame 7. And certainly, the docking portion may also be separately arranged as an annular groove in a side wall of the outer frame 7, and the like, and the purpose of rapid positioning can also be achieved. Wherein, the fixing device comprises a connecting rod 13 and a connecting hole 14 arranged at a side of the connector 8, the adjacent impeller assemblies 5 are fixed by inserting the connecting rod 13 into the connecting hole 14, and the connecting rod 13 is in interference fit with the connecting hole 14. Quick docking of the impeller assemblies 5 can be realized by engagement of the annular bulge 12 with the docking portion for positioning and then by interference fit of the connecting rod 13 with the connecting hole 14, and the connection is firm and reliable, and the operation is simple.

As shown in the figures, the connecting rod 13 is fixedly connected to the connector 8 at a middle portion of the connecting rod 13, the connecting hole 14 is arranged at one end of the connecting rod 13. The production process and assembly process of the product is simplified by providing the connecting hole 14 at the connecting rod 13.

As shown in the figures, in order to mount the present invention on a side wall of the aquarium, the present invention further comprises a first magnet 15 and a second magnet 16, wherein the first magnet 15 is mounted on the connecting rod 13, the first magnet 15 and the second magnet 16 are cooperative to fasten the impeller assemblies 5 on the side wall of the aquarium. A relatively large static friction between the first magnet 15, the second magnet 16, and the side wall of the aquarium is generated through mutual attraction between the first magnet 15 and the second magnet 16, so as to realize relative fixing between the first magnet 15, the second magnet 16, and the side wall of the aquarium. The method in which the structure is mounted is fast, convenient, stable and reliable.

As shown in the figures, a plurality of first baffles 17 are arranged at the water inlet 10, the first baffle 17 is vertical to the rotating shaft 9. A plurality of second baffles 18 are arranged in the water outlet 11, and the second baffles 18 are distributed in a four-square shape. The cooperation of the first baffle 17 and the second baffle 18 can realize internal turbulent flow of the water and increase the circulation effect of the water flow.

As shown in the figures, the housing 1 is detachably connected with a connecting block 19 at a side of the housing 1, the connecting block 19 is provided with a mounting hole in interference fit with the connecting rod 13, so that the impeller assembly 5 can be fixed with the housing 1. The connecting block 19 is provided with a clamping groove, and the housing 1 is provided with a clamping buckle 3 matched with the clamping groove at the side of the housing 1, so that the housing 1 is quickly disassembled from the connecting block 19.

The embodiments above are merely preferred solutions of the present invention, and other embodiments are also possible for the present invention. Equivalent variations or substitutions may be made by those skilled in the art without departing from the scope of the present invention, and these variations or substitutions shall all included in the scope defined in the claims of the present application.

What is claimed is:

1. A modularly assembled wave maker, comprising:
a housing internally provided with a power source with an output end extending out of the housing; and
at least one impeller assembly, the at least one impeller assembly including:
a first end connected to the housing;
an expanded structure for continuing the impeller assembly; and
an impeller body connected to the output end of the power source in a transmission way.

2. The modularly assembled wave maker according to claim 1, wherein the impeller assembly further includes:
an outer frame having a water inlet and a water outlet; and
a connector detachably connected to an end of the outer frame,
wherein the impeller body has a first end connected to the output end of the power source and a second end rotatably mounted on the connector via a rotating shaft extending out of the connector.

3. The modularly assembled wave maker according to claim 2, wherein the at least one impeller assembly is configured to be docked to at least one adjacent impeller assembly, the expanded structure having a positioning device for docking of the at least one adjacent impeller assembly and a fixing device for fixing a docking state of the at least one adjacent impeller assembly.

4. The modularly assembled wave maker according to claim 3, wherein the positioning device has an annular bulge arranged at the connector and a docking portion arranged at an end portion of the outer frame away from the connector for cooperation with the annular bulge, the outer frame of the at least one adjacent impeller assembly being positioned by inserting the annular bulge into the docking portion.

5. The modularly assembled wave maker according to claim 3, wherein the fixing device has a connecting rod and a connecting hole arranged at a side of the connector, the at least one adjacent impeller assembly being fixed by inserting the connecting rod into the connecting hole, the connecting rod being in interference fit with the connecting hole.

6. The modularly assembled wave maker according to claim 5, wherein the connecting rod is fixedly connected to the connector at a middle portion of the connecting rod, the connecting hole being arranged at one end of the connecting rod.

7. The modularly assembled wave maker according to claim 5, further comprising a first magnet and a second magnet, wherein the first magnet is mounted on the connecting rod, the first magnet and the second magnet being configured for fixing cooperatively the impeller assembly to a side wall of the aquarium.

8. The modularly assembled wave maker according to claim 2, wherein a plurality of first baffles vertical to the rotating shaft are arranged at the water inlet, and a plurality of second baffles are arranged in the water outlet, the plurality of second baffles being distributed in a four-square shape.

9. The modularly assembled wave maker according to claim 5, wherein the housing is detachably connected at a side of the housing with a connecting block, the connecting block having a mounting hole in interference fit with the connecting rod.

10. The modularly assembled wave maker according to claim 5, wherein the connecting block has a clamping groove, the housing being provided at a side of the housing with a clamping buckle cooperative with the clamping groove.
